(19) United States
(12) Patent Application Publication
(10) Pub. No.: US 2026/0151968 A1
(43) Pub. Date: Jun. 4, 2026

(54) WELDING TOOL FOR WELDING PLASTIC FILMS

(71) Applicant: ROPEX Industrie-Elektronik GmbH, Bietigheim-Bissingen (DE)

(72) Inventors: Manuel SCHULLER, Bietigheim-Bissingen (DE); Lucas DIESSE, Bietigheim-Bissingen (DE)

(21) Appl. No.: 19/398,702

(22) Filed: Nov. 24, 2025

(30) Foreign Application Priority Data
Nov. 29, 2024 (EP) 24216550.4

(51) Int. Cl. B29C 65/00; B29C 65/22

(52) U.S. Cl. CPC B29C 66/81871; B29C 65/224; B29C 66/0042; B29C 66/43; B29C 66/81811

(57) ABSTRACT

A welding tool for welding plastic films, with a carrier part that has a mechanical interface for coupling to a welding device and with a support surface. At least one recess is formed in the support surface, which recess is fluidically connected to a fluid channel in the carrier part, and with a heating band arrangement which rests on the carrier surface and includes an electrically conductive heating band which is accommodated between an electrically insulating base layer and an electrically insulating cover layer. The base layer is provided with an opening which covers the recess at least in some areas.

### CROSS-REFERENCE TO RELATED APPLICATION

This application claims priority to European application no. 24216550.4 filed Nov. 29, 2024, which is incorporated by reference.

### BACKGROUND

The invention relates to a welding tool for welding plastic films. Such welding tools are marketed by the applicant under the name RESISTRON® and typically feature a rectangular metal rail, also referred to as a carrier part, and a heating band resting on the rail, which can be connected to a power source to enable heat to be transferred to a plastic film when current flows through the heating band. The plastic film is in contact with the heating band and is pressed against it by a counterplate, which is designed in the form of a bar, for example. The heating band usually has a multi-layer structure, which typically comprises an electrically insulating base layer, an electrically conductive heating band, and an electrically insulating cover layer. Different structures for the heating band may also be provided.

### SUMMARY

The object of the invention is to provide a welding tool with which the welding process can be accelerated.

This task is solved for a welding tool for welding plastic films by providing a carrier part that has a mechanical interface for coupling to a welding device and a carrier surface, wherein at least one recess is formed in the carrier surface, which is fluidically connected to a fluid channel in the carrier part, is provided with a heating band arrangement which rests on the carrier surface and comprises an electrically conductive heating band which is accommodated between an electrically insulating base layer and an electrically insulating cover layer, the base layer being provided with an opening which covers the recess at least in some areas.

The function of the carrier part is to provide mechanical support for the heating band resting on the carrier surface and to enable force transmission between the welding device and the counterplate attached to the welding device. The plastic films to be welded together are held in a welding gap defined by the heating band and the counterplate, wherein the size of the welding gap is adjustable. It is preferable that the distance between the heating band and the counterplate is adjusted by a linear relative movement between the carrier part and the counterplate. It is particularly preferred that a heating plane determined by the heating band, which also may be called a heating tape, and a pressure plane determined by the counterplate are aligned parallel to each other and that the linear relative movement between the carrier part and the counterplate is carried out in a spatial direction that is oriented parallel to a surface normal of the heating plane and parallel to a surface normal of the pressure plane.

The heating band arrangement can be regarded as an assembly that is placed on the support surface of the carrier part. The heating band arrangement comprises an electrically insulating base layer that is designed to provide electrical insulation between the electrically conductive heating band and the support surface, which is typically made from metal and therefore electrically conductive. The base layer also serves as an elastic buffer between the carrier surface and the electrically conductive heating band, for example to compensate for differences in thickness in the plastic films to be welded. When the welding tool is used as intended, an electric current flows through the electrically conductive heating band. The heating band converts electrical energy into heat energy due to its electrical resistance, which heat energy can be used to cause the desired local heating of the previously fed plastic films. To prevent the locally plasticized and therefore almost melted plastic film from adhering to the electrically conductive heating band, a cover layer is provided which covers the electrically conductive heating band and is made of a heat-resistant material which has only a low, preferably no, tendency to adhere to the plasticized plastic film.

Unlike known welding tools, which are available in both uncooled and liquid-cooled versions, the welding tool according to the invention has a carrier part which is provided with a recess on the carrier surface, which recess is connected in a fluidic communicating manner to a fluid channel formed in the carrier part. In contrast to previously known welding tools, in which a closed cooling circuit using a cooling liquid, for example water, is provided, the welding tool according to the invention is configured for dissipative cooling (loss cooling), in which a gas flow supplied to the fluid channel from a fluid source, in particular a compressed air source, can escape through the recess in the carrier surface. In order to ensure that the gas flow exits the recess with as little resistance as possible, the base layer resting directly on the support surface is provided with an opening. The base layer is placed on the recess in the carrier surface in such a way that there is at least partial overlap between the opening in the base layer and the recess in the carrier surface, so that the gas flow can also flow through the base layer. This gas flow, which is supplied either continuously or intermittently to the fluid channel in the carrier part and can flow out from there through the recess and the opening, has a cooling effect on the heating band. This cooling effect, which supports the cooling of the heating band after the flow of current through the heating band has ended, allows the weld seam produced with the aid of the welding tool to be cooled quickly, resulting in a shorter cycle time and a higher cycle frequency for successive welding operations. Purely by way of example, the recess may be a bore extending between the fluid channel and the support surface.

The fluid channel in the carrier part may have a single fluid connection located on an outer surface of the carrier part and designed, for example, to couple a fluid hose extending between the fluid source and the carrier part. In this case, pure loss cooling is provided, in which a fluid mass flow provided at the fluid connection flows completely through the recess and the opening and exits the heating band arrangement, which also may be called a heating tape arrangement. Several fluid connections may also be provided, all of which are used exclusively for supplying fluid to the fluid channel. Alternatively, the fluid channel in the carrier part may extend between an inlet connection and an outlet connection, which are each arranged on an outer surface of the carrier part. In this case, it may be provided that a fluid hose connected to the fluid source can be coupled to the inlet connection. Furthermore, it may be provided that an adjustable throttle is arranged at the inlet connection or at the outlet connection and/or a silencer is arranged at the outlet connection, through which a predetermined flow resistance for the fluid is effected, so that a first part of the fluid provided at the inlet connection flows through the recess in the carrier surface into the heating band, while a second portion of the fluid supplied to the inlet connection flows to the outlet connection and can be discharged from there into the environment.

Advantageous further developments of the invention are the subject of the subclaims.

It is advantageous if the base layer comprises an insulating tape made of a rubber-elastic material and a sliding tape, wherein the sliding tape is arranged between the insulating tape and the heating band and wherein the opening is formed in the insulating tape and protrudes in a lateral direction beyond the heating band. The function of the insulation tape, which forms part of the base layer, is to ensure electrical insulation between the current-carrying heating band and the carrier part. Furthermore, the insulation tape made of a rubber-elastic material provides a mechanical buffer effect to compensate for geometric tolerances that can occur, in particular, in the plastic films to be welded. The function of the sliding tape is to prevent the heating band from adhering to the insulating tape, so that during the welding process, at least slight relative movements between the heating band and the insulating tape are possible in the heating plane determined by the heating band, thereby avoiding undesirable internal stresses in the heating band.

Furthermore, it is provided that the insulating tape is provided with at least one opening which, when the heating band arrangement is used as intended, protrudes laterally beyond the heating band in the heating plane, so that a fluid flow originating from the fluid channel in the carrier part can flow through the recess and the opening can flow laterally along the heating band, thereby enabling the desired cooling effect for the heating band. In this case, it may be provided, purely by way of example, that the sliding tape is designed in the same strip-shaped manner as the heating band and that the sliding tape does not protrude laterally beyond the heating band, or only protrudes slightly in lateral direction beyond the heating band. Here, it may be provided that the heating band and the sliding band do not cover the opening or only cover it slightly.

Alternatively, it may be provided that the opening extends below the heating band and the sliding band and protrudes laterally beyond the heating band and the sliding band, so that the heating band can be flowed around on both sides by a fluid flow flowing through the opening.

For example, the support surface may be rectangular in shape, with two longer edges running parallel to each other and shorter edges aligned at right angles to the longer edges. Preferably, the longer edges are 5 to 100 times longer than the shorter edges. A practical range for the longer edges extends between 10 cm and 800 cm. The distance between the longer edges corresponds to the length of the shorter edges and is also referred to as the width of the carrier surface. The length of the longer edges is also referred to as the length of the carrier surface.

Furthermore, it is provided that the insulating tape covers the carrier surface at least almost completely and that the heating band extends almost over the entire length of the longer edge of the carrier surface. Preferably, it is provided that an extension of the heating band in the direction of the width of the carrier surface is only a fraction, for example 30 percent, of the width of the carrier surface.

Depending on the arrangement of the opening in the base layer, it may be provided that the sliding tape and the heating band border the opening or are arranged adjacent to the opening or partially cover the opening.

It is advantageous if the sliding tape has a perforation that is arranged in at least partial coverage with the opening formed in the insulating tape. The perforation in the sliding tape can be designed as a single hole or as a plurality of holes. Preferably, the perforation is designed as a plurality of holes arranged at equal intervals along an axis of extension. It is particularly preferable for the axis of extension to be aligned parallel to the longer edge of the carrier surface. Such a configuration of the sliding tape is particularly interesting if the sliding tape is considerably wider than the heating band, whereby the fluid flow can flow through the perforation in the sliding tape and around the heating band.

It is preferred that the insulating tape is made of electrically insulating silicone and/or that the heating band is made of metal, in particular stainless steel, and/or that the sliding tape is made of a PTFE-coated fabric tape and/or that the cover layer is made of a PTFE-coated fabric tape, in particular one provided with a single-sided self-adhesive layer. The use of a fabric tape with a PTFE coating (polytetrafluoroethylene coating) for the sliding tape and/or for the top layer prevents unwanted adhesion between the heating band and the insulating tape and/or between the top layer and the plastic films to be welded.

In a further development of the invention, the recess in the carrier surface is designed as a groove. A plurality of holes, in particular aligned transversely to the carrier surface, are formed between the fluid channel and the groove along a longitudinal axis of the groove. It is preferably provided that the groove has a constant profile, for example a U-shaped or V-shaped profile, along the longitudinal axis and that the longitudinal axis of the groove is aligned parallel to the longer edge of the carrier surface. In order to ensure the most uniform possible distribution of the fluid flows to be supplied to the groove via the fluid channel, a plurality of holes is formed between the fluid channel and the groove along the longitudinal axis. It is preferred that the holes are aligned transversely to the support surface. It is particularly preferred that the arrangement of the holes along the longitudinal axis of the groove and/or the cross-sections of the holes are selected such that at least substantially the same fluid mass flow is provided at each point of the groove in order to avoid local undercooling or overcooling of the heating band. Purely by way of example, it may be provided that the distance between adjacent holes is reduced with increasing distance from the inlet connection at which the pressurized fluid is provided, in order to take into account the pressure drop in the fluid channel over the length of the fluid channel.

In addition or alternatively, it may be provided that the cross-sections of the bores become larger with increasing distance from the inlet connection in order to also take into account the pressure drop in the fluid channel over the length of the fluid channel. Furthermore, it may be provided, for example, that the fluid channel has a significantly larger cross-section than the sum of the cross-sections of the bores transverse to the carrier surface, in order to ensure an even distribution of the fluid mass flow. The arrangement of the bores may be provided on a straight line or on a zigzag line or according to another geometric specification. In addition or as an alternative, several grooves with associated holes may also be provided to enable advantageous adaptation of the cooling capacity to the geometry of the carrier surface.

In a further embodiment of the invention, the insulating tape is provided with a plurality of openings arranged along the longitudinal axis of the groove in a first pitch. Preferably, the first pitch is selected such that sufficiently stable webs remain between adjacent openings in the insulating tape on which the sliding tape and the heating band can rest in order to ensure sufficient mechanical support even in the area of the groove formed in the carrier surface.

It is advantageous if a plurality of perforations is formed in the sliding tape, with the perforations being arranged in the same pitch as the openings in the insulating tape. This arrangement of the perforations ensures advantageous low flow resistance, provided that there is complete coverage between the openings in the insulating tape and the perforations in the sliding tape. Such complete coverage can be facilitated, for example, by additional aids such as positioning pins in the carrier part and corresponding positioning holes in the insulating tape and in the sliding tape.

In an advantageous further development of the invention, the cover layer is provided to cover the heating band and the base layer, and the cover layer is provided with outlet openings away from the heating band. The outlet openings in the cover layer arranged away from the heating band prevent the heating band from coming into direct contact with the plastic films to be welded. In addition, this also ensures that the electrical insulation function that the cover layer must provide is not compromised. The outlet openings are preferably arranged at the edges of the carrier surface, in particular along the longer edges of the carrier surface. This also ensures that the fluid flows emerging through the outlet openings do not hit the area of the plastic films that are to be welded with the help of the heating band, and which can be referred to as the welding zone. Instead, this welding zone is cooled by the fluid flowing between the sliding tape and the top layer, which exits through the openings or perforations, flows around the heating band, and flows away to the outlet openings.

It is preferable that the carrier surface is rectangular in shape and that the side surfaces of the carrier part adjacent to the longest edges of the carrier surface are covered in areas by the cover layer, with the outlet openings being arranged adjacent to the longest edge of the carrier surface.

It is advantageous if, when the openings and perforations and the outlet openings are projected to a projection surface, which is oriented parallel to the surface of the carrier part, there is at least partial, in particular complete, coverage of the openings and perforations and if the outlet openings are arranged without coverage and away from the openings and perforations. The partial, in particular complete, covering of the openings and the perforations ensures low-resistance fluid flow through the base layer, which is typically formed by the insulating tape and the sliding tape. The arrangement of the outlet openings away from the openings and perforations is intended to ensure that the fluid flowing out of the perforations comes into intensive contact with the heating band in order to achieve efficient heat dissipation from the heating band before the fluid flows out through the outlet openings into the environment of the welding tool.

In a further embodiment of the invention, it is provided that a distance between the side surfaces of the carrier part facing away from each other corresponds to at least twice the width of the heating band and that the heating band has an equal distance to both side surfaces.

It is preferably provided that the sliding band with the heating band resting on it, together with the cover layer, forms two cooling channels aligned mirror-symmetrically to each other, which are designed for a gas flow between the recess in the carrier part and the outlet openings. Through these cooling channels, the fluid flowing out of the perforations in the sliding tape is guided along the heating band to the outlet openings.

### BRIEF DESCRIPTION OF THE DRAWINGS

An advantageous embodiment of the invention is shown in the drawing. Here shows:

FIG. 1 a purely schematic perspective exploded view of a welding tool according to the invention, and

FIG. 2 a purely schematic cross-sectional view of the welding tool according to FIG. 1.

### DETAILED DESCRIPTION

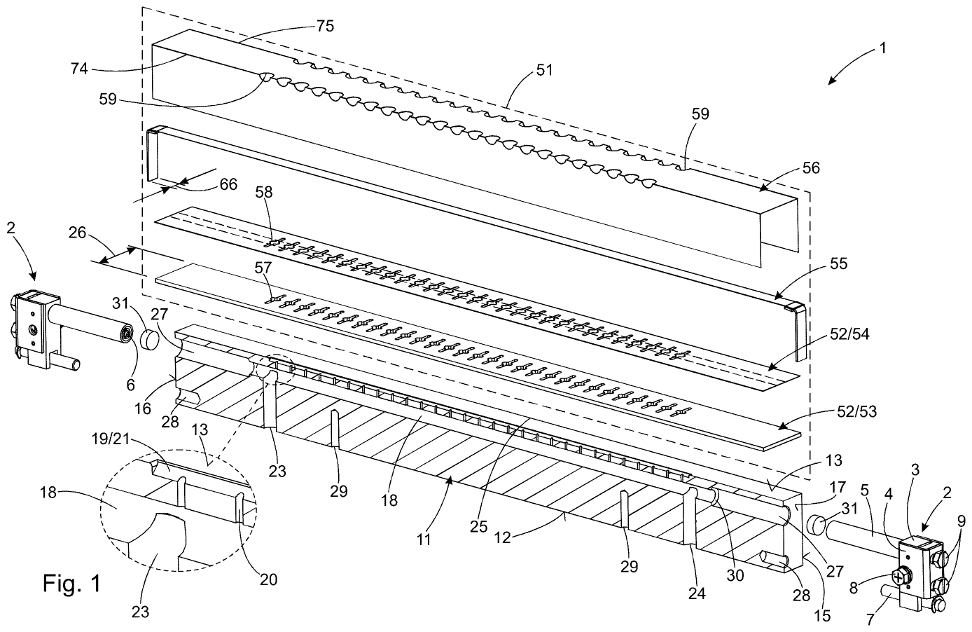

The exploded view in FIG. 1 shows the essential components of the embodiment of a welding tool 1 shown there. Each of these components is to be understood as purely exemplary and can also be realized in other ways through modifications. The welding tool 1 shown in FIG. 1 comprises two clamping heads 2, a carrier part 11, and a heating band arrangement 51, which, after assembly of these components, is intended for use in a welding device, which welding device is not shown.

The carrier part 11 shown in a sectional view is designed in a purely exemplary rectangular shape and is made of a metallic material, for example stainless steel or aluminum. On a purely exemplary flat underside 12 of the carrier part 11, which can also be used as an interface for attaching the welding tool 1 to a welding device, two threaded holes 29 are provided purely as an example, with which the welding tool 1 can be fixed to a corresponding holder of the welding device.

Furthermore, a first fluid connection hole 23 and a second fluid connection hole 24 are provided on the underside 12, each spaced apart from the threaded holes 29, through which, for example, compressed air can be supplied to a fluid channel 18 that passes through the carrier part 11. As can be seen from the illustration in FIG. 1, the fluid channel 18 extends parallel to a longer edge 25 of the carrier part 11, which can also be referred to as the longest edge, as a through hole from a first end face 16 of the carrier part 11 to a second end face 17 of the carrier part 11. The fluid channel 18 is designed as a spring hole 27 starting from the first end face 16 or the second end face 17, which is intended to accommodate a spring sleeve 5 of the respective clamping head 2 and a respective associated sealing plug 31. Away from the spring bores 27, the fluid channel 18 has a reduced diameter compared to the spring bores 27.

Starting from the fluid channel 18, a plurality of bores 20 extend in a spatial direction that is oriented transversely to the underside 12 and transversely to an upper side 13 aligned parallel to the underside 12. The bores 20 serve to provide a fluidic connection between the fluid channel 18 and a recess 19 in the upper side of the carrier part 11, also referred to as the carrier surface 13. Purely by way of example, it is envisaged that the bores 20 are each of circular cylindrical shape and are arranged parallel to the longer edge 25 of the support surface 13 at equal intervals.

Between the underside 12 and the support surface 13, there are flat side surfaces 14, 15 and end surfaces 16 and 17, which are aligned at right angles to each other.

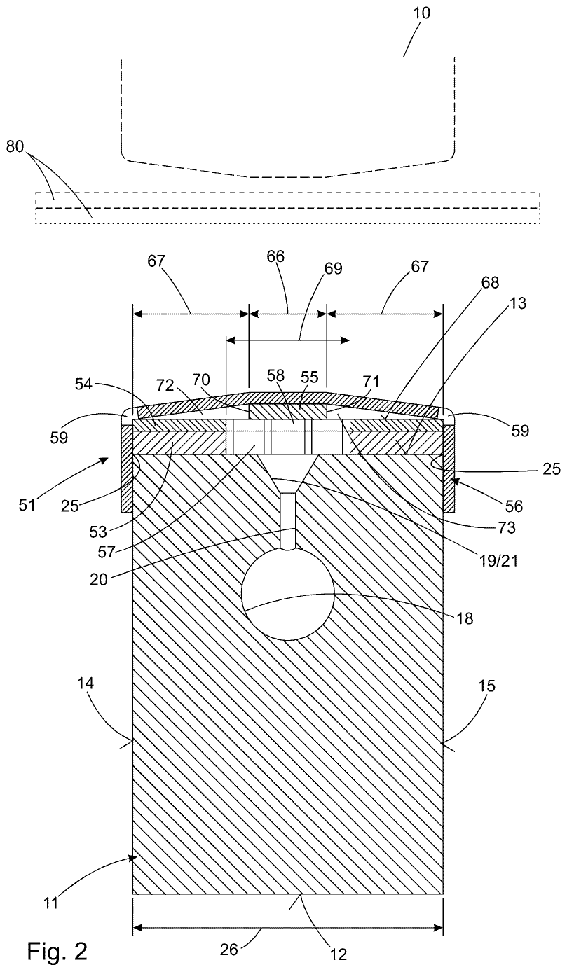

As can be seen from the illustration in FIG. 2, the recess 19, which is designed as a groove 21, has an essentially U-shaped profile, which is constant over the entire length of the groove 21, purely by way of example.

Starting from the first end face 16 and the second end face 17, guide bores 28 extend parallel to the fluid channel 18 and are designed as blind holes, which together with the spring bores 27 serve to positively fix the clamping heads 2 in spatial directions transverse to the longer edge 25.

For example, each of the clamping heads 2 has a cuboid base body 3 which is provided with a spring sleeve 5 and a guide pin 7, the spring sleeve 5 and the guide pin 7 being aligned parallel to each other. A spring 6 is arranged in the respective spring sleeve 5, which spring 6 protrudes axially beyond the spring sleeve 5 in a relaxation position not shown and is provided for support on a sealing plug 31, which is supported on a ring collar 30 and seals the fluid channel 27. The ring collar 30 results from the difference in diameter between the spring bore 27 and the rest of the fluid channel 18. These springs 6 enable the heating band 55 clamped at the respective clamping heads 2 to be held permanently under a predefined preload. To secure the heating band 55 to the respective clamping head 2, the clamping head 2 comprises a clamping clip 4 provided with clamping screws 9. With the aid of the clamping screws 9, the heating band 55, described in more detail below, can be secured to the respective clamping head 2. A fastening screw 8 is also attached to the clamping clamp 8, which is intended for attaching an electrical supply cable which is not shown.

The heating band 55, made of an electrically conductive material, preferably a metallic material, in particular stainless steel, has a length that is greater than the longest edge 25 of the carrier part 11 and is bent at each end by 90 degrees, with the bent sections of the heating band 55 serving to secure it to the respective clamping head 2. The width 66 of the heating band 55 is, purely by way of example, approximately 30 percent of the length of a shorter edge 26 of the support surface 13. The heating band 55 thus has a distance 67 from the respective adjacent longest edge 25 that is slightly greater than the width 66 of the heating band 55.

A base layer 52 is arranged between the heating band 55 and the carrier surface 13, which, purely by way of example, comprises an insulating tape 53 and a sliding tape 54. For example, the insulating tape 53, which is made of silicone in particular, has rubber-elastic properties in order to compensate to a certain extent for geometric deviations that may be present in the plastic films 80 to be welded with the aid of the welding tool 1 and a counterplate 10, which is only symbolically shown in FIG. 2. The function of the sliding tape 54, which rests on the insulating tape 53 and is adjacent to the heating band 55, is to allow slight compensating movements of the heating band 55 in a plane of movement 68 that is identical to the upper side of the sliding tape 54.

In order to allow a fluid flow for cooling the heating band 55, the insulation tape 53 is provided with a plurality of openings 57, which are arranged parallel to the longest edge 25 of the carrier surface 13 at equal intervals. The openings 57 have an extension 69 in a spatial direction that is aligned transversely to the longest edge 25, which is greater than the width 66 of the heating band 55. In order to enable the fluid to flow through the sliding tape 54 as unimpeded as possible, the sliding tape 54 is provided with a plurality of perforations 58, which are formed and arranged to coincide with the openings 57 in the insulating tape 53.

As can be seen from the purely schematic representation in FIG. 2, the sliding band 54, the heating band 55, and the cover layer 56 covering the heating band 55 form two cooling channels 72, 73, each with a triangular cross-section. Each of the cooling channels 72, 73 is located directly adjacent to a first side surface 70 or a second side surface 71 of the heating band 55. As a result, fluid supplied via the fluid channel 18, the bores 20, the groove 21, the openings 57, and the perforations 58 must flow past the side surfaces 70, 71 of the heating band 55 before the fluid can flow out into the environment through outlet openings 59 in the cover layer 56. This ensures the desired cooling effect for the heating band 55 by means of the flowing fluid.

In order to ensure targeted guidance of the fluid flows from the two cooling channels 72, 73 to the outlet openings 59 of the cover layer 56, the cover layer 56 not only covers the heating band 55 and the base layer 52 formed by the insulating tape 53 and the sliding tape 54, but also covers the side surfaces 14, 15 of the carrier part 11 in certain areas. For this purpose, it is provided that the cover layer made of a PTFE film or an equivalent material is at least substantially U-shaped and that the outlet openings 59 are each arranged along bend lines 74, 75.

1. A welding tool for welding plastic films, with a carrier part that has a mechanical interface for coupling to a welding device and with a support surface, wherein at least one recess is formed in the support surface, which recess is fluidically connected to a fluid channel in the carrier part, and with a heating band arrangement which rests on the carrier surface and comprises an electrically conductive heating band which is accommodated between an electrically insulating base layer and an electrically insulating cover layer, wherein the base layer is provided with an opening which covers the recess at least in some areas.

2. The welding tool according to claim 1, wherein the base layer comprises an insulating tape made of a rubber-elastic material and a sliding tape, wherein the sliding tape is arranged between the insulating tape and the heating band and wherein the opening is formed in the insulating tape and laterally protrudes beyond the heating band.

3. The welding tool according to claim 2, wherein the sliding tape has a perforation which is arranged at least partially overlapping the opening formed in the insulating tape.

4. The welding tool according claim 1, wherein the insulating tape is made of electrically insulating silicone and/or that the heating band is made of metal and/or that the sliding tape is designed as PTFE fabric tape and/or that the cover layer is designed as PTFE fabric tape.

5. The welding tool according claim 1, wherein the recess in the support surface is designed as a groove and that a plurality of holes are formed along a longitudinal axis of the groove between the fluid channel and the groove.

6. The welding tool according to claim 5, wherein the insulating tape is provided with a plurality of openings which are arranged along the longitudinal axis of the groove in a first pitch.

7. The welding tool according to claim 6, wherein a plurality of perforations is formed in the sliding tape, wherein the perforations are arranged in the first pitch of the openings in the insulating tape.

8. The welding tool according claim 1, wherein the cover layer covers the heating band and the base layer and that the cover layer is provided with outlet openings away from the heating band.

9. The welding tool according to claim 8, wherein the support surface is rectangular in shape and that side surfaces of the carrier part adjacent to the longest edges of the support surface are covered in areas by the cover layer, wherein the outlet openings are located adjacent to the longest edge of the support surface.

10. The welding tool according to claim 9, wherein, when the openings and perforations and outlet openings are projected, there is at least partial coverage of the openings and the perforations and the outlet openings are arranged without overlap and away from the openings and the perforations.

11. The welding tool according to claim 9, wherein a distance between the facing side surfaces of the carrier part corresponds to at least twice the width of the heating band and that the heating band is at the same distance from both side surfaces.

12. The welding tool according to claim 1, wherein the sliding tape with the heating band resting on it, together with the cover layer, forms two cooling channels that are aligned mirror-symmetrically to each other that are designed for a gas flow between the recess in the carrier part and the outlet openings.

13. The welding tool according to claim 10, wherein a distance between the facing side surfaces of the carrier part corresponds to at least twice the width of the heating band and that the heating band is at the same distance from both side surfaces.
